(19) United States
(12) Patent Application Publication
(10) Pub. No.: US 2026/0220614 A1
(43) Pub. Date: Jul. 30, 2026

(54) SYSTEM AND METHOD FOR MONITORING LEVEL CROSSING

(71) Applicant: HACK PARTNERS LIMITED, Devizes Wiltshire (GB)

(72) Inventors: Harvey STEDMAN, Devizes Wiltshire (GB); Milda GIRCYTE, Devizes Wiltshire (GB); Haydon BARTLETT-TASKER, Tonbridge (GB)

(73) Assignee: HACK PARTNERS LIMITED, Devizes Wiltshire (GB)

(21) Appl. No.: 19/141,492

(22) PCT Filed: Dec. 20, 2023
(86) PCT No.: PCT/IB2023/063011

§ 371 Date: Jun. 20, 2025

(30) Foreign Application Priority Data
Dec. 20, 2022 (GB) 2219232.2

(51) Int. Cl. G06Q 10/20; B61K 9/08; B61L 23/04; G06T 7/00; G06V 10/74; G06V 20/52

(52) U.S. Cl. CPC G06Q 10/20; B61K 9/08; B61L 23/04; G06T 7/0002; G06V 10/761; G06V 20/52; G06T 2207/30232

(57) ABSTRACT

A system for monitoring a level crossing, wherein the system includes at least one imaging sensor configured to capture a plurality of images of the level crossing and a processor communicably coupled to the at least one imaging sensor. Moreover, the processor is configured to receive the plurality of images from the at least one imaging sensor, determine a level of a railway track and a level of a road by processing the plurality of images, and identify a level-fault when a difference between the level of the railway track and the level of the road exceeds a predetermined level-tolerance. The present disclosure also proposes a method for monitoring a level crossing.

### FIELD OF THE INVENTION

This invention relates to monitoring level crossings. In particular, though not exclusively, this invention relates to a system for monitoring a level crossing and a method for monitoring a level crossing.

### BACKGROUND

Demand for transportation by railway is continuously increasing. Often, railway lines traverse roads. This increasing demand has necessitated a large number of level crossings on railway tracks to be constructed, to enable trains and road vehicles to coexist. Typically, a given level crossing is defined as an intersection of a railway track and a road, wherein the railway track and the road are substantially at a mutually same level. The given level crossing is also known as a grade crossing, railroad crossing, or railway crossing. Level crossings are critical for railway operations. Railway infrastructure authorities are facing issues in managing and controlling various risks associated with a manner in which level crossings function. Notably, a given railway track may be at a level that is misaligned with a level of a road that is traversed by the railway track. In such a condition, a level crossing potentially leads to a serious accident when there is both concurrently traffic on the railway track and the road. Therefore, railway infrastructure authorities have to inspect each level crossing to monitor the level of railway tracks and roads and identify whether or not the level crossing needs to be repaired.

Surveyors from railway infrastructure authorities regularly inspect the level of railway tracks and roads at each level crossing. Typically, the inspection is carried out pursuant to a method including attaching two sticks with a string. The string is tied at a height in accordance with a clearance standard set by the railway authority. Then, pursuant to the method, two surveyors walk parallel to each other across the level crossing, with the sticks touching a ground surface and the string tied at the clearance standard height. During the walk, if anything hits the string, it is classed as a defect and is logged for maintenance purposes. However, said method is an incredibly time-consuming and manually-intensive task and increases the risk to track workers being struck by a train of road vehicle. Moreover, during the inspection, train services cannot run for a significant period of time.

Therefore, in the light of the foregoing discussion, there exists a need to overcome the aforementioned drawbacks associated with monitoring level crossings.

### SUMMARY OF THE INVENTION

A first aspect of the invention provides a system for monitoring a level crossing, the system comprising:
at least one imaging sensor configured to capture a plurality of images of the level crossing; and
a processor communicably coupled to the at least one imaging sensor, wherein the processor is configured to:
   receive the plurality of images from the at least one imaging sensor,
   determine a level of a railway track and a level of a road by processing the plurality of images, and
   identify a level-fault when a difference between the level of the railway track and the level of the road exceeds a predetermined level-tolerance.

The system for monitoring a level crossing, when in operation, determines the level of the railway track and the level of the road and identifies a level-fault when the difference between the level of the railway track and the level of the road exceeds the predetermined level-tolerance, namely a predetermined tolerance threshold. It will be appreciated that the system monitors the level crossing, which is beneficially cost-effective, improves safety and improves inspection accuracy.

Throughout the present disclosure, the term “level crossing” as used herein refers to an intersection where a railway line crosses a road or a road crosses the railway line. Typically, before a train passes through a level crossing, barriers on the road are lowered which prevent vehicles on the road from crossing the level crossing. When a train passes through the level crossing, the vehicles on the road usually remain stationary behind the lowered barriers. After the train passes, the barriers are usually lifted and the vehicles are allowed to pass the railway track through the level crossing.

The term “monitoring” as used herein refers to continuous or periodic observation and recording activities to ensure quality and/or documentation. The monitoring enables the real-time surveillance of the railway track and the road. Optionally, the monitoring enables the maintenance-entity to monitor the level crossing from any remote location. Optionally, the remote location includes, but is not limited to, a home, hospital, hotel, workplace, or other areas. It will be appreciated that the at least one imaging sensor may be used for monitoring the level crossing to enable the maintenance-entity to record a variety of information in real-time such as the movement of barriers, signal lights, audio message, level of the railway track and the road.

The term “at least one imaging sensor” as used herein refers to one or more imaging sensors to record a plurality of images, for example a temporal sequence of images, of the level crossing. Optionally, the at least one imaging sensor may capture a video of the level crossing. Herein, the plurality of images may be frames of each of the videos captured by the at least one imaging sensor. Optionally, the at least one imaging sensor may be a depth camera. It will be appreciated that the depth camera is capable of recording a two-dimensional image (representing visual information of a scene) and a depth image (representing distances of various points in the scene), from the depth camera. Optionally, the at least one imaging sensor may be a fish-eye camera, for example having a field-of-view greater than 120°. Optionally, the at least one imaging sensor may be wide-angle camera, for example having a field-of-view greater than 150°. For example, upon start of operation, a local processor associated with the at least one imaging sensor may boot into an interactive user interface, and the at least one imaging sensor may be connected with the interactive user interface. Then, the interactive user interface may automatically set a configuration of the at least one imaging sensor to a calibration that was previously-determined by local testing of the at least one imaging sensor. Then, the capturing of the plurality of images may start upon selection of an interface element, for example, such as a button, in the interactive user interface. The local processor is optionally a processor of a user device associated with a user, wherein the user uses the user device to control operation of the at least one imaging sensor. Alternatively, the local processor is optionally the processor of the system. The local processor may be configured to also record metadata of the at least one imaging sensor and geolocation data captured by at least one geolocation sensor arranged in proximity of the at least one imaging sensor. Then, the local processor may be configured to send the plurality of images to the processor of the system, optionally along with the metadata and the geolocation data. Optionally, the system further comprises the at least one geolocation sensor. The at least one geolocation sensor may, for example, be a Global Positioning System (GPS) receiver.

Optionally, the calibration to which the configuration of the at least one imaging sensor is set, is optimized for at least one of: an exposure, a white balance setting, according to outdoor use. In this regard, the calibration is optimized based on lighting and weather conditions in outdoor environments. Optionally, a plurality of such optimized calibrations may be previously-determined by local testing of the at least one imaging sensor.

The term “plurality of images” as used herein refers to the two or more images which provide a visual representation of the level crossing, captured by the at least one imaging sensor. When the at least one imaging sensor is the depth camera, the plurality of images optionally comprises a plurality of two-dimensional images and their corresponding depth images. Typically, the plurality of images reflects a graphic representation and is used to store remotely sensed imagery, e.g. level of the railway track, the level of the road, and the like. Optionally, the video data may be a collection of the plurality of images of the level crossing. Optionally the plurality of images may be configured to determine the defect in the level crossing.

Throughout the present disclosure, the term “processor” as used herein refers to a hardware, software, firmware, or a combination of these configured to control operation of the system. In this regard, the processor performs several complex processing tasks. The processor is capable of running drivers for the at least one imaging sensor, along with custom scripts. Optionally, the processor may be a processor of a server (for example, such as a central server) that is communicably coupled to a plurality of imaging sensors via a plurality of local processors associated with the plurality of imaging sensors. The processor is communicably coupled to other components of the system wirelessly and/or in a wired manner. In an example, the processor may be implemented as a programmable digital signal processor (DSP). In another example, the processor may be implemented via a cloud server that provides a cloud computing service. Optionally, the processor is communicably coupled to the at least one imaging sensor using a communication network. The communication network may be a wired network, a wireless network, or any combination thereof. Examples of the communication network include, but are not limited to, Local Area Networks (LANs), Wide Area Networks (WANs), Internet, radio networks and telecommunication networks. Notably, the processor receives the plurality of images through the communication network. Beneficially, once received, the processor processes the images to timely identify the defect to the level crossing. In this regard, the plurality of images is stored at a data repository of the system, wherein the processor is communicably coupled with the data repository.

It will be appreciated that the processor is operably coupled with the at least one imaging sensor configured to receive the plurality of images. Optionally, such coupling may be via the local processor associated with the at least one imaging sensor. The plurality of images depicts the level of the railway track and the level of the road. The plurality of images are processed, for example, using a multi-stage processing pipeline. Data from said pipeline may be saved into the data repository of the system. Optionally, prior to processing the plurality of images, the processor is configured to:
pre-process the plurality of images to ensure that they are capable of being processed further; and
save the plurality of images into at least one format that is suitable for further processing.

In this regard, the pre-processing of the plurality of images includes, for example, one or more image processing operations such as image reorientation, image resizing, image flipping, image cropping, adjusting lighting levels in image, saturation adjustment, grayscale, adjusting exposure settings (for example, employing different exposures), and the like. Furthermore, examples of the at least one formant into which the plurality of images are saved include, but are not limited to, a Joint Photographic Experts Group (JPEG/JPG) format, a Portable Network Graphics (PNG) format, a Tagged Image File Format (TIFF), and a Bitmap format (BMP).

Optionally, when determining the level of the railway track and the level of the road by processing the plurality of images, the processor is configured to:
generate a three-dimensional reconstruction of the level crossing, by applying at least one photogrammetry technique to the plurality of images;
scale the three-dimensional reconstruction and align the three-dimensional reconstruction to a predefined coordinate system;
calculate the level of the railway track, using first elevation data of data elements of the three-dimensional reconstruction which represent the railway track, said first elevation data being determined using the predefined coordinate system; and
calculate the level of the road, using second elevation data of data elements of the three-dimensional reconstruction which represent the road, said second elevation data being determined using the predefined coordinate system.

In this regard, the at least one photogrammetry technique may comprise a feature extraction technique, a pairwise matching technique, a bundle adjustment technique, and a projection technique, a merging technique. The feature extraction technique identifies distinctive feature within the plurality of images, such features being one or more of corners, edges, blobs, patterns, and the like. The feature extraction technique is optionally implemented using Scale-Invariant Feature Transform (SIFT) or Speeded Up Robust Features (SURF). The pairwise matching technique may compare extracted features between pairs of images (amongst the plurality of images) to identify corresponding points. The bundle adjustment technique enables in optimizing alignment of the plurality of images simultaneously, thereby improving an accuracy of the three-dimensional reconstruction. The projection technique may, for example, project three-dimensional approximations (such as three-dimensional point clouds) from each image and the merging technique may merge the projected three-dimensional point clouds. The at least one photogrammetry technique is beneficial in enabling an accurate determination of the levels of the railway track and the road. Obtaining such accuracy is not possible by merely calculating depth disparity between the plurality of images, as in such a case, measurements along the level crossing beyond what is represented in the plurality of images, are not feasible or inaccurate. The at least one photogrammetry technique overcomes this problem by enabling generation of the (full) three-dimensional reconstruction of the level crossing, which upon scaling, facilitates accurate calculation of the levels of the railway track and the road.

Furthermore, in the above regard, the three-dimensional reconstruction which is generated by applying the at least one photogrammetry technique to the plurality of images, is dense, accurate, but unscaled. Optionally, when scaling the three-dimensional reconstruction, the processor is configured to: calculate a scale factor, based on the three-dimensional approximations (such as the three-dimensional point clouds) from each image; and apply the scale factor to the three-dimensional reconstruction. Optionally, upon scaling, the three-dimensional reconstruction has a 1:1 scale with respect to the level crossing in reality. Optionally, the calculation of the scale factor may also take into account the depth images amongst the plurality of images. These depth images may be timestamped.

Optionally, when aligning the three-dimensional reconstruction to the predefined coordinate system, the processor is configured to: estimate a pose of the at least one imaging sensor at a time of capturing each image amongst the plurality of images; and manipulate the three-dimensional reconstruction and the pose of the at least one imaging sensor using at least one transformation, for alignment with the predefined coordinate system. The pose of the at least one imaging sensor is optionally alternatively estimated when generating the three-dimensional reconstruction of the level crossing. Herein, the term “pose” encompasses position and/or orientation.

Optionally, the first elevation data comprises elevation values (namely, height values) of the data elements representing the railway track. Similarly, optionally, the second elevation data comprises elevation values (namely, height values) of the data elements representing the road. The “data elements” are optionally, for example, point clouds, meshes, or similar. The elevation values are optionally determined using an axis of the predefined coordinate system which corresponds to elevation (i.e., height) of the level crossing. Beneficially, when the levels of the railway track and the road are calculated in this matter, the levels are highly accurate.

Optionally, when determining the level of the railway track and the level of the road by processing the plurality of images, the processor is further configured to perform at least one of:
removing vegetation edge cases for the level crossing,
determining a geometry of the level crossing,
determining which level crossing has been monitored,
limiting an area that is to be processed within the plurality of images, based on the pose of the at least one imaging sensor,
performing geometric processing of the three-dimensional reconstruction of the level crossing, to sample an area of interest in the level crossing.

Optionally, when removing the vegetation edge cases for the level crossing, the processor is configured to:
extract a central strip of data that corresponds to an area over the level crossing, from the three-dimensional reconstruction of the level crossing, wherein the central strip comprises:
   data lying below a maximum height of a highest position of the at least one imaging sensor, and
   data lying between a minimum imaging position and a maximum imaging position of the at least one imaging sensor; and
align the central strip with the three-dimensional reconstruction such that the central strip is aligned with an exact region where image capturing took place.

In this regard, confining the central strip to the data lying below the maximum height of the highest position of the at least one imaging sensor is performed to exclude portions of the three-dimensional reconstruction representing trees or vegetation located above the estimated positions of the at least one imaging sensor. Moreover, further confining the central strip to the data lying between the minimum imaging position and the maximum imaging position of the at least one imaging sensor is performed to exclude any challenging points located behind or in front of the at least one imaging sensor, ensuring that only relevant data within said positions is considered. The alignment of the central strip with the three-dimensional reconstruction is crucial for assessing the reconstructed data in relation to the exact region where the image capturing took place. Such removal of the vegetation edge cases yields a refined and focused dataset i.e., the central strip excluding vegetation outside recording boundaries of the at least one imaging sensor, which minimizes impact of vegetation when the three-dimensional reconstruction is processed.

Optionally, when determining the geometry of the level crossing, the processor is configured to:
remove at least one of: noise, occluded data elements, in the three-dimensional reconstruction, to obtain a clean representation of a surface of the level crossing;
identify at least one section of the surface, based on at least one point on the clean representation of the surface at which the geometry of the level crossing is to be determined; and
reconstruct the surface of the level crossing, based on the clean representation of the surface, by performing a geometry determination operation on each section of the surface, wherein the geometry determination operation comprises: fitting lines of specified lengths within each section, determining a gradient between the lines; and identifying the geometry of the level crossing at the at least one point, based on the gradient.

In this regard, the processor is beneficially configured to accurately monitor level crossings having a variety of geometries such as a flat geometry, a concave geometry, a convex geometry, a freeform geometry, and the like. By such geometry determination, the determination of the levels of the railway track and the road is performed accurately, and subsequently, the identification of level faults is also accurate. Optionally, when the geometry of the level crossing is determined, the processor is further configured to identify whether data elements representing the road are present at the gradient or within a threshold value above the gradient. In other words, the processor is further configured to determine a measurement of heights of the data elements representing the road and whether said heights comply with a regulatory standard that is required for a compliant level crossing. The threshold value may be selected based on a regulatory standard that is used in a geographical region where the level crossing is present. For example, the threshold value may be 0.15 metres.

Optionally, when determining which level crossing has been monitored, the processor is configured to match the geolocation data captured by the at least one geolocation sensor arranged in proximity of the at least one imaging sensor, with a pre-known geographical and or asset record of level crossings in a geographical region.

Optionally, when limiting the area that is to be processed within the plurality of images, the processor is configured to: identify at least one object that is visible in each image from amongst the plurality of images; and determine the area that is to be processed within each image, based on a type of the at least one object and the pose of the at least one imaging sensor. The area that is to be processed is a region of inspection within each image, and this region can be different for different images. The area that is to be processed excludes certain types of objects which are not of interest for inspection of level faults as they are not technically relevant for the same. Such types of objects may, for example, be lineside buildings and structures, vegetation, lamp posts, street signs, furniture, and the like. Moreover, the pose of the at least one imaging sensor may also optionally be used for determining the area that is to be processed, as a position and an extent of said area within each image depends on said pose. A technical effect of limiting the area to be processed is that it prevents processing of additional and unwanted data, and thus makes the system's computational burden lighter. As a result, it becomes easier for the user to operate the system and prevent spurious results.

Optionally, when performing geometric processing of the three-dimensional reconstruction of the level crossing, the processor is configured to: determine dimensions of objects present in the three-dimensional reconstruction; and identify the area of interest as an area which includes objects and their portions within a predefined range of heights. This range of heights are optionally fixed (i.e., pre-set) or dynamic (i.e., adjusted based on user input). The area of interest optionally includes only those objects which have heights that are comparable with typical levels of the road and the railway track, or only those portions of objects which are in proximity of the levels of the road and the railway track, or similar, since representations of only such objects would impact the determination of the level of the road and the level of the railway track. For example, the area of interest could include roads, railway tracks, dirt tracks, level crossing barriers, small vegetation along the road, sidewalks, and the like, based on such geometric processing.

Optionally, the system further comprises a pose-tracking means coupled to the at least one imaging sensor, wherein the processor is configured to:
determine a pose of the at least one imaging sensor at a time of capturing the plurality of images, by processing pose-tracking data collected by the pose-tracking means; and
utilise the pose of the at least one imaging sensor when determining the level of the railway track and the level of the road.

In this regard, the processor may be understood to perform fusion of the pose-tracking data (or the pose of the at least one imaging sensor) with the plurality of images, for determining the level of the railway track and the level of the road. Optionally, the pose-tracking means comprises at least one of: an accelerometer, a gyroscope, a magnetometer, an inertial measurement unit. The pose-tracking means may optionally be integrated with the at least one imaging sensor, be physically coupled to the at least one imaging sensor, or similar. The pose-tracking means may be optionally arranged on a vehicle (for example, a rail vehicle, a road vehicle), on a moving device, on a structure located at the level crossing, or similar. The pose of the at least one imaging sensor may be optionally utilised, along with the plurality of images, to improve an accuracy of the determination of the level of the railway track and the level of the road. Optionally, when utilising the pose of the at least one imaging sensor for determining the level of the railway track and the level of the road, the processor is configured to perform at least one of:
correct distortions that are present in the plurality of images, wherein the distortions are caused by movement of the at least one imaging device, said movement being indicated by changes in the pose of the at least one imaging sensor;
compensate for blur and distortions in the plurality of images while the plurality of images are being captured, based on changes in the pose of the at least one imaging sensor;
improve an accuracy of the three-dimensional reconstruction of the level crossing and/or an accuracy of the alignment of the three-dimensional reconstruction, based on the pose of the at least one imaging device. Such accuracy improvement may, for example, be on account of one or more of: better scale estimation, dynamic environment compensation, context-aware geometric adjustment, drift correction, that are optionally performed by the processor, based on the pose of the at least one imaging device.

Moreover, based on processing of the received plurality of images, the processor is configured to determine a level-fault. The term “level-fault” as used herein refers to a difference between the level of the railway track and the level of the road being greater than a predetermined level-tolerance. Typically, the level of the railway track and the level of the road are defined by a height between a ground surface and top surface of the railway track and the road, respectively. Ideally, a level crossing without any fault or defect should not have any difference in the heights between the ground surface and the top surfaces of the railway track and the road. In simple terms, the top surfaces of the railway track and the road should lie at a same height from the ground surface. Therefore, if there exists any difference in the heights between the ground surface and the top surfaces of the railway track and the road, and such difference in the heights exceed the predetermined level-tolerance, namely threshold, then such instances may be termed as level faults. In simple terms, the level faults exists when the railway track is either elevated or depressed in terms of height when compared to the road, or vice versa. Generally, such elevation and depression may be caused due to deposition of soil or debris on the road, and wear and tear of the railway track and the road, respectively.

The processor is configured to determine a level-fault in the level of the railway track and the level of the road associated with the level crossing. For example, the level-fault may arise due to the presence of a rock on the railway track that may increases the level of the road and/or the railway track. In another example, the level-fault may arise due to a piece of chipped metal protruding from the railway track. The term “predetermined level-tolerance” as used herein refers to the allowable clearance height specified by the regulating authority between the railway track and the level of the road. It will be appreciated that the regulating authority may be a railway authority, a maintenance-entity who are responsible to maintain standards related to the level crossing. Typically, during the detection of the level-fault, the plurality of images captured is provided to the processor to identify the location of the fault.

Optionally, the predetermined level-tolerance lies in a range of 0.01 centimetres to 30 centimetres. For example, the predetermined level-tolerance may be from 0.01, 0.05, 0.1, 0.2, 0.5, 1, 2, 5, 7.5, 10, 15, or 20 centimetres, up to 0.25, 0.75, 3, 6, 12, 14, 17.5, 20, 22.5, 25, 28, or 30 centimetres. It will be appreciated that the aforementioned range is exemplary, and other ranges for the predetermined level-tolerance may also be feasible.

Optionally, the processor is configured to detect further defects associated with the level crossing, or further defects within the vicinity of the level crossing. Such further defects may include, for example, damage to the barrier, missing components on the level crossing, cracks in the road, debris in the vicinity of the level crossing. In the event that such further defects are identified by the processor, the processor may be further configured to take a corresponding action to the action that would have been taken had the further defect been a level-fault.

Optionally, the processor is further configured to:
generate an alert indicative of the level-fault, and
communicate the alert to a device associated with a maintenance-entity responsible for maintaining health of the level crossing.

In this regard, the alert is generated and is communicated to the device once the defect is determined in the level crossing. The term “alert” as used herein refers to a form of signal or a message that is conveyed to the maintenance-entity responsible for maintaining the health of the level crossing. Notably, the maintenance-entity may be an individual or a group of individuals responsible for the continuous operation of the level crossing. Herein, the alert is targeted to the maintenance-entity such as to fix the level crossing and avert any potential problems with the level crossing. Advantageously, the maintenance-entity can timely fix the detected fault before a major fault occurs. The term “device” as used herein refers to a hardware machine such as a computer, a laptop, a mobile, and so forth, associated with the processor to communicate the alert to the maintenance-entity responsible for maintaining the health of the level crossing.

Optionally, the processor is further configured to suggest a corrective action to be performed for correcting the level-fault of the level crossing. The term “corrective action” as used herein refers to a physical action which is performed by the maintenance-entity for rectifying the level-fault associated with the level crossing. Suitably, the alert is an indicative of the corrective action. Examples of the corrective action include, but are not limited to, repairing the damages associated with the railway track, and repairing the damages associated with the road. It will be appreciated that the corrective action accurately instructs the maintenance-entity in rectifying faults with respect to the level crossing. Beneficially, the corrective action saves the time and effort of the maintenance-entity in determining the corrective measure.

Notably, the alert is indicative of the corrective action. For example, if the level-fault is determined at the level crossing at Hampden Park, an alert will be generated with respect to the detected level-fault at Hampden Park indicating a corrective action to be performed. Optionally, a set of corrective actions for remedying issues with respect to the level crossing when the level of the railway track and/or the level of the road exceed the predetermined level-tolerance will be issued. In this regard, the set of corrective actions may be stored at the data repository associated with the processor. Moreover, each corrective action from the set of corrective actions may be pre-determined for remedying defects associated with respect to the level crossing. Beneficially, the corrective action is indicated in the alert enables the maintenance-entity to timely resolve the level-fault to the level crossing to avoid accidents.

Optionally, the alert comprises information associated with at least one of: the level-fault, a location, an image capturing time of the level crossing. In this regard, the location of the level crossing and the image capturing time of the plurality of images is determined based on a location of at least one imaging sensor that captured the plurality of images. Moreover, the location information helps the maintenance-entity to identify the location of the level-fault. For example, the predetermined level-tolerance may be 1 centimetre (cm) between the level of the railway track and the level of the road. However, at Helpston the level of the railway track may be measured as 1.5 cm by the processor using the at least one imaging sensor then the alert will be generated and communicated to the maintenance-entity to rectify the level of the said railway track. Moreover, the plurality of images may be provided to the maintenance-entity in the alert for confirming the location of the fault. The maintenance-entity may be able to assess the plurality of images to verify the fault. It will be appreciated that the location assists in determining an accurate location and the plurality of images assist in determining the exact position of the defect at the image capturing time for remedying the defect to the level crossing. Advantageously, the plurality of images being provided to the maintenance-entity in the form of the alert allows the maintenance-entity to confirm the defect and thereby helps in reducing the time taken during the manual inspection.

Optionally, the at least one imaging sensor is installed at at least one of: within a vehicle, externally on a vehicle, strapped to a person or to a device carried by the person, on a movable device, an object present at the level crossing. In this regard, the vehicle is optionally a rail vehicle (for example, such as a passenger train, a freight train, a maintenance-of-way rail vehicle, a work train, or similar), a road vehicle (for example, such as a two-wheeler vehicle, a three-wheeler vehicle, a car, a lorry, a road construction vehicle, or similar), an aerial vehicle (for example, a drone, or similar), and the like. Optionally, the at least one imaging sensor is installed within (i.e., inside) the vehicle and thus captures the plurality of images of the level crossing from inside the vehicle. It will be appreciated that, in such a case, the installation is preferably done in a manner that vehicle or its parts do not obstruct a view of the at least one imaging device. Optionally, the at least one imaging sensor is installed externally on the vehicle. For example, when the vehicle is the rail vehicle, the at least one imaging sensor may be installed externally on one or more of a front surface, a back surface, a bottom surface, a side surface of the rail vehicle. Optionally, the at least one imaging sensor is strapped to the person or to the device carried by the person. For example, the imaging sensor may be strapped to a body part of a person, or to the device (such as a portable electronic device, a walking stick, a backpack, or similar object) carried by the person. Optionally, the at least one imaging sensor is installed on a movable device. In this regard, the movable device may, for example, be a robot. Optionally, the at least one imaging sensor is installed at the object present at the level crossing. The object may, for example, be a sign post, a light, a barrier gate, or similar. The at least one imaging sensor is configured to capture the plurality of images and provide the captured plurality of images to the process to identify the level-defect. Moreover, the processor informs the maintenance-entity regarding the determined level-fault via the alert. The at least one imaging sensor is configured to capture different perspective views in order to avoid any false detection of the defect. Optionally, the at least one imaging sensor may capture the perspective view, side view, top view or a combination thereof.

Optionally, the at least one imaging sensor is configured to capture the plurality of images of the level crossing depicting ground surface and top surfaces of the railway track and the road. Suitably, the environment is an environment comprising railway transportation infrastructure. The ground surface is the surface above which the railway tracks is place and/or the surface upon which the road is constructed. The environment includes, but is not limited to, a train, a railway track, a road, at least one railway station. Optionally, the at least one imaging sensor comprises the levels of the railway track. Optionally, the at least one imaging sensor comprises the levels of road. It will be appreciated that the plurality of images enables the processor to determine the defect. Optionally, the processor is configured to process the plurality of images to identify the level-fault in real time.

Optionally, the processor is configured to:
determine the levels of the railway track and the road by determining a height between the ground surface and top surfaces the railway track and the road, respectively, and
identify the level-fault by determining a difference in heights, of the ground surface and top surfaces the railway track and the road, exceeding the predetermined level-tolerance.

In this regard, the height between the ground surface and the top surface of the railway track and the road is determined. Notably the processor is configured to determine the difference in height between the ground level and the railway track and the ground level and the road. Based on the difference in heights, the process is configured identity the level-fault. Suitably the processor compares the difference in heights with the predetermined level-tolerance.

Optionally, the processor employs at least one computer vision algorithm for processing the plurality of images depicting the level of railway track and the level of the road to determine the level-fault of the level crossing. The term “computer vision algorithm” as used herein refers to an algorithm that enables a computer to recognise objects and/or defects when processing the images. Herein, the at least one computer vision algorithm is utilised to determine the level-defect to the level crossing. It will be appreciated that the at least one computer vision algorithm utilises pattern recognition to determine any variation (i.e., change in level of the railway track and road with respect to the predetermined level-tolerance) in the level crossing. Examples of the at least one computer vision algorithm include, but are not limited to, a scale-invariant feature transform (SIFT) algorithm, a speeded up robust features (SURF) algorithm, a Viola-Jones object detection algorithm, a Lucas-Kanade optical flow algorithm, a Kalman filter algorithm, a mean shift algorithm, an adaptive thresholding algorithm, a graph cut algorithm, a “you only look once” (YOLO) algorithm. Beneficially, the at least one computer vision algorithm accurately processes the plurality of images, and thereby reducing false-positive results. Moreover, the at least one computer vision algorithm is time-effective as it utilises processing capabilities, assisting in timely remedying the defect to the level crossing. It will be appreciated that timely detecting the defect to the level crossing is beneficial since an underlying level-fault may be fixed in a timely manner to avoid incurring losses.

Optionally, the at least one processor is further configured to:
generate statistical information based on the level-fault of the level crossing; and
represent, via an interactive user interface, at least one of: the statistical information, a report generated based on the statistical information. The term “statistical information” as used herein refers to information which provides statistical insights regarding the monitoring of the level crossing. Examples of the statistical information include, but are not limited to, a time at which the alert was generated, a maintenance-entity for whom the alert was generated, duration of time level crossing is analysed, a number of alerts raised, a number of level crossing analysed, a number of level-fault detected within area. Optionally, the statistical information is represented in the form of at least one of: data values, a representation of data values. Examples of the representation of data values include, but are not limited to, a histogram, a pie chart, a line diagram, a heat map. For example, the statistical information pertaining to the number of level crossings analysed in one day may be represented as a number (i.e., the data value), and the statistical information pertaining to a number of level crossings analysed per day over multiple days (i.e., the representation of data values) may be represented as a bar graph or a line diagram.

The term “interactive user interface” as used herein refers to an interface that is used by the maintenance-entity to view the statistical information. Optionally, the interactive user interface is displayed on the device associated with the maintenance-entity. It will be appreciated that at least one of: the statistical information, the report generated based on the statistical information are represented to the maintenance-entity via the interactive user interface. The term “report” as used herein refers to an analysis of the statistical information in an organized format. The report may be represented in at least one of: a written form, a graphical form, or a combination of the written form and the graphical form. Optionally, the processor is configured to generate the report, based on the statistical information. Optionally, the report is represented to the maintenance-entity. Beneficially, the statistical information and the report provides in-depth insight with respect to the detected level-fault at the level-crossing.

Optionally, the processor is further configured to:
generate at least one of: information pertaining to results of the processing of the plurality of images, processing metadata related to the processing of the plurality of images; and
provide, via the interactive user interface, the at least one of: the information, the processing metadata.

In this regard, the results of the processing of the plurality of images are optionally intermediate results and/or final results of one or more processing steps which are performed by the at least one processor. A technical effect of doing so is that the user is enabled to observe and analyse additional relevant information regarding the level crossing, irrespective of presence or absence of the level-fault, following which the user may accordingly initiate maintenance actions and/or corrective actions accordingly.

Optionally, the processor is further configured to:
generate at least one of: a video, an image thumbnail, using the plurality of images; and
provide, via the interactive user interface, the at least one of: the video, the image thumbnail.

In this regard, there is beneficially enabled convenient viewing of the video (comprising one or more of the plurality of images) and convenient identification of the video via the thumbnail, by the user.

Optionally, the local processor or the processor of the system is configured to generate a visualization and inspection form that is to be finalized and submitted by the user, and to provide the visualization and inspection form via the interactive user interface. In the visualization and inspection form, the user may, for example, indicate the user's preferences regarding one or more of which level crossing is to be inspected, duration of said inspection, how the visualization of the level crossing is to be generated, and the like.

Optionally, the processor is further configured to automatically populate and reconcile asset reference information of the level crossing, based on the processing of the plurality of images. The asset reference information comprises at least one of: a type of the level crossing, a size of the level crossing, the geometry of the level crossing.

A second aspect of the invention provides a method for (namely, a method of) monitoring a level crossing, the method comprising:
capturing a plurality of images of the level crossing using at least one imaging sensor;
receiving the plurality of images from the at least one imaging sensor;
determining a level of a railway track and a level of a road by processing the plurality of images; and
identifying a level-fault when a difference between the level of the railway track and the level of the road exceeds a predetermined level-tolerance.

Optionally, method further comprises:
generating an alert indicative of the level-fault, and
communicating the alert to a device associated with a maintenance-entity responsible for maintaining health of the level crossing.

Optionally, the method further comprises suggesting a corrective action to be performed for correcting the level-fault of the level crossing.

Optionally, the alert comprises information associated with at least one of: the level-fault, a location, an image capturing time of the level crossing.

Optionally, the method employs (namely, uses) at least one computer vision algorithm for processing the plurality of images depicting the level of railway track and the level of the road to determine the level-fault of the level crossing.

Optionally, the method further comprises:
generating statistical information based on the level-fault of the level crossing; and
representing, via an interactive user interface, at least one of: the statistical information, a report generated based on the statistical information.

Optionally, in the method, the step of determining the level of the railway track and the level of the road by processing the plurality of images comprises:
generating a three-dimensional reconstruction of the level crossing, by applying at least one photogrammetry technique to the plurality of images;
scaling the three-dimensional reconstruction and align the three-dimensional reconstruction to a predefined coordinate system;
calculating the level of the railway track, using first elevation data of data elements of the three-dimensional reconstruction which represent the railway track, said first elevation data being determined using the predefined coordinate system; and
calculating the level of the road, using second elevation data of data elements of the three-dimensional reconstruction which represent the road, said second elevation data being determined using the predefined coordinate system.

Optionally, in the method, the step of determining the level of the railway track and the level of the road by processing the plurality of images further comprises performing at least one of:
removing vegetation edge cases for the level crossing,
determining a geometry of the level crossing,
determining which level crossing has been monitored,
limiting an area that is to be processed within the plurality of images, based on the pose of the at least one imaging sensor,
performing geometric processing of the three-dimensional reconstruction of the level crossing, to sample an area of interest in the level crossing.

Optionally, the method further comprises:
determining a pose of the at least one imaging sensor at a time of capturing the plurality of images, by processing pose-tracking data collected by a pose-tracking means, wherein the pose-tracking means coupled to the at least one imaging sensor; and
utilising the pose of the at least one imaging sensor when determining the level of the railway track and the level of the road.

A third aspect of the invention provides a computer program product for monitoring a level crossing, the computer program product comprising a non-transitory machine-readable data storage medium having stored thereon program instructions that, when executed by a processing device, cause the processing device to:
control at least one imaging sensor to capture a plurality of images of the level crossing,
receive the plurality of images from the at least one imaging sensor,
determine a level of a railway track and a level of a road by processing the plurality of images, and
identify a level-fault when a difference between the level of the railway track and the level of the road exceeds a predetermined level-tolerance.

In an embodiment, the non-transitory machine-readable date storage medium can direct a machine (such as computer, other programmable data processing apparatus, or other devices) to function in a particular manner, such that the program instructions stored in the non-transitory machine-readable data storage medium case a series of steps to implement the function specified in a flowchart corresponding to the instructions. Examples of the non-transitory machine-readable data storage medium includes, but is not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is an illustration of a block diagram of a system for monitoring a level crossing, in accordance with an embodiment of the invention;

FIG. 2 is an exemplary illustration of an image captured of an environment by at least one imaging sensor, in accordance with an embodiment of the present disclosure;

FIG. 3 is an illustration of statistical information represented via an interactive user interface, in accordance with different embodiments of the present disclosure; and

FIG. 4 is a flowchart illustrating steps of a method for monitoring a level crossing, in accordance with an embodiment of the present disclosure.

### DETAILED DESCRIPTION

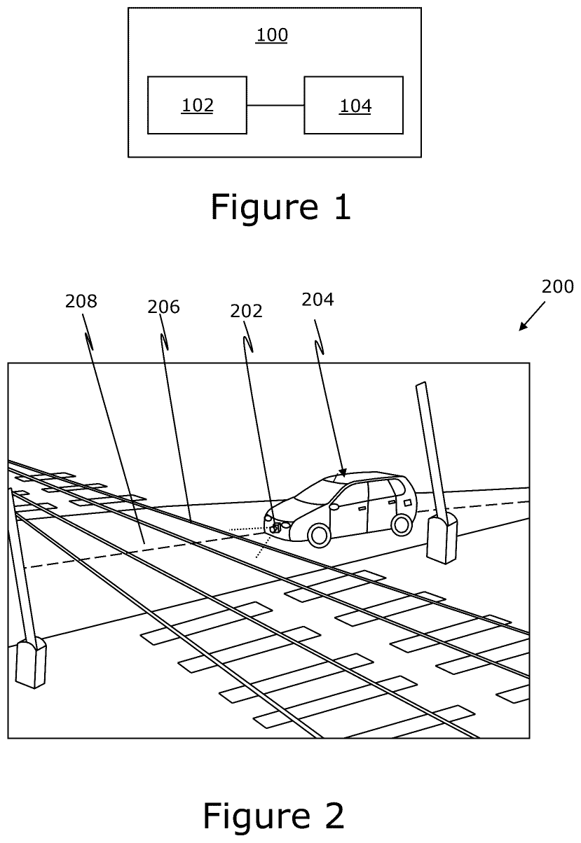

Referring to FIG. 1, illustrated is a block diagram of a system 100 for monitoring a level crossing, in accordance with an embodiment of the present disclosure. As shown, the system 100 comprises at least one imaging sensor 102 and a processor 104 communicably coupled to the imaging sensor 102. The imaging sensor 102 is configured to capture a plurality of images of the level crossing depicting ground surface and the top surfaces of a railway track and a road. Moreover, the imaging sensor 102 may be arranged within a vehicle, externally on a vehicle, or strapped to a person to capture a field of view. The processor 104 is configured to receive the plurality of images from the imaging sensor 102, and process the images to determine the level of the railway track and the level of the road by processing the plurality of images to identify a level-fault therebetween.

Referring next to FIG. 2, illustrated is a schematic illustration of an environment for implementing a system 200 for monitoring a level crossing, in accordance with an embodiment of the present disclosure. As shown, the system 200 comprises at least one imaging sensor 202 arranged on vehicle 204. The imaging sensor 202, in operation, captures a plurality of images of the level crossing in which the view of a railway track 206 and road 208 is captured. As shown, the imaging sensor 202 is arranged on the front of vehicle 204 and is moved along the level crossing. Optionally, the imaging sensor 202 may be arranged on rear of the vehicle 204. Optionally, the imaging sensor 202 may be arranged anywhere on the vehicle. Notably, during the complete travelling along the level crossing, the imaging sensor 202, arranged in front of the vehicle, is configured to capture the plurality of images to analyse the level of the railway track 206 and the level of road 208. The imaging sensor 202 is arranged such that the level crossing would lie in its field of view.

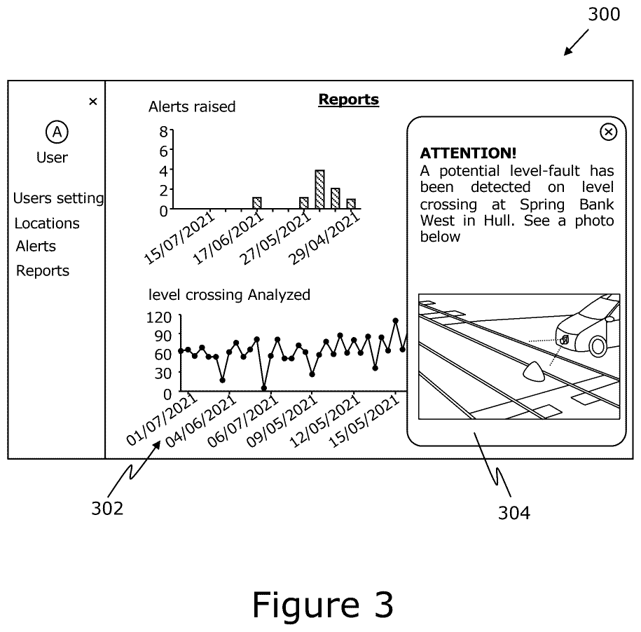

Referring to FIG. 3, illustrated is statistical information 300 represented via an interactive user interface, in accordance with different embodiments of the present disclosure. The statistical information 300 is generated based on at least one of: damage to a level crossing, variation of level between the railway track and the road. Optionally, at least one of: the statistical information 300, a report generated based on the statistical information 300, is represented via the interactive user interface. As shown, the statistical information 300 comprises at least one of: a histogram 302, an alert 304. The histogram 302 is indicative of a history of alerts raised and the level crossing analysed on different days. The alert 304 is indicative of the level fault at the level crossing. Optionally, the alert 304 also comprises at least one of: a location of the level crossing at a time of capturing the plurality of images, the plurality of images depicting the defect to the level crossing. Optionally, the alert 304 is also indicative of a corrective action to be performed for remedying the level-fault to the level crossing.

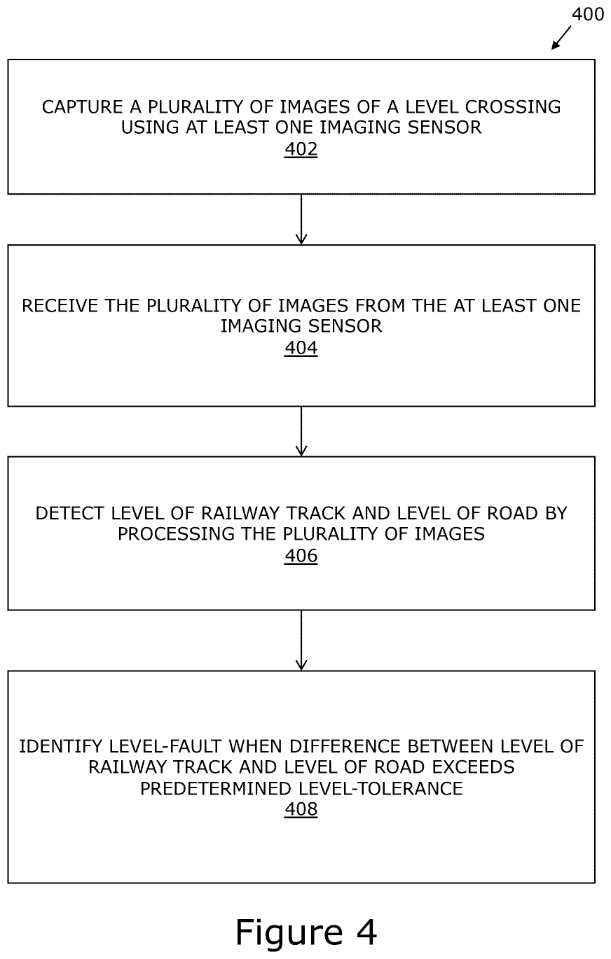

Referring to FIG. 4, illustrated is a flowchart illustrating steps of a method 400 for monitoring a level crossing. At a step 402, a plurality of images of the level crossing is captured using at least one imaging sensor. At a step 404, the plurality of images is received from the at least one imaging sensor. At a step 406, a level of a railway track and a level of a road is determined by processing the plurality of images. At a step 408, a level-fault is identified when a difference between the level of the railway track and the level of the road exceeds a predetermined level-tolerance.

The steps 402, 404, 406 and 408 are only illustrative and other alternatives can also be provided where one or more steps are added, one or more steps are removed, or one or more steps are provided in a different sequence without departing from the scope of the claims herein.

1-22. (canceled)

23. A system for monitoring a level crossing, the system comprising at least one imaging sensor configured to capture a plurality of images of the level crossing; and a processor communicably coupled to the at least one imaging sensor, wherein the processor is configured to:
receive the plurality of images from the at least one imaging sensor,
determine a level of a railway track and a level of a road by processing the plurality of images, and
identify a level-fault when a difference between the level of the railway track and the level of the road exceeds a predetermined level-tolerance.

24. A system according to claim 23, wherein the processor is further configured to:
generate an alert indicative of the level-fault, and
communicate the alert to a device associated with a maintenance-entity responsible for maintaining health of the level crossing.

25. A system according to claim 23, wherein the processor is further configured to suggest a corrective action to be performed for correcting the level-fault of the level crossing.

26. A system according to claim 24, wherein the alert comprises information associated with at least one of: the level-fault, a location, an image capturing time of the level crossing.

27. The system according to claim 23, wherein the at least one imaging sensor is installed at least one of: within a vehicle, externally on a vehicle, strapped to a person.

28. A system according to claim 23, wherein the at least one imaging sensor is configured to capture the plurality of images of the level crossing depicting ground surface and top surfaces of the railway track and the road.

29. A system according to claim 28, wherein the processor is configured to:
determine the levels of the railway track and the road by determining a height between the ground surface and top surfaces the railway track and the road, respectively, and
identify the level-fault by determining a difference in heights, of the ground surface and top surfaces the railway track and the road, exceeding the predetermined level-tolerance.

30. A system according to claim 28, wherein the processor employs at least one computer vision algorithm for processing the plurality of images depicting the level of railway track and the level of the road to determine the level-fault of the level crossing.

31. A system according to claim 23, wherein the at least one processor is further configured to generate statistical information based on the level-fault of the level crossing; and represent, via an interactive user interface, at least one of: the statistical information, a report generated based on the statistical information.

32. A method for monitoring a level crossing, the method comprising:
capturing a plurality of images of the level crossing using at least one imaging sensor;
receiving the plurality of images from the at least one imaging sensor;
determining a level of a railway track and a level of a road by processing the plurality of images; and
identifying a level-fault when a difference between the level of the railway track and the level of the road exceeds a predetermined level-tolerance.

33. A method according to claim 32, wherein the method further comprises:
generating an alert indicative of the level-fault, and
communicating the alert to a device associated with a maintenance-entity responsible for maintaining health of the level crossing.

34. A method according to claim 32, wherein the method further comprises suggesting a corrective action to be performed for correcting the level-fault of the level crossing.

35. A method according to claim 33, wherein the alert comprises information associated with at least one of: the level-fault, a location, an image capturing time of the level crossing.

36. A method according to claim 32, wherein the method employs at least one computer vision algorithm for processing the plurality of images depicting the level of railway track and the level of the road to determine the level-fault of the level crossing.

37. A method according to claim 32, wherein the method further comprises:
generating statistical information based on the level-fault of the level crossing; and
representing, via an interactive user interface, at least one of: the statistical information, a report generated based on the statistical information.

38. A computer program product for monitoring a level crossing, the computer program product comprising a non-transitory machine-readable data storage medium having stored thereon program instructions that, when executed by a processing device, cause the processing device to:
control at least one imaging sensor to capture a plurality of images of the level crossing,
receive the plurality of images from the at least one imaging sensor,
determine a level of a railway track and a level of a road by processing the plurality of images, and
identify a level-fault when a difference between the level of the railway track and the level of the road exceeds a predetermined level-tolerance.
